(19) United States
(12) Patent Application Publication
(10) Pub. No.: US 2003/0031197 A1
(43) Pub. Date: Feb. 13, 2003

(54) Multiple arbitration circuit

(76) Inventor: Steven G. Schmidt, Mount Holly, NJ (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/927,359

(22) Filed: Aug. 13, 2001

(51) Int. Cl. H04J 3/02

(52) U.S. Cl. 370/462; 710/240

(57) ABSTRACT

A multiple arbitration circuit capable of simultaneously arbitrating multiple paths from at least one source port to at least one destination port through a switch. The circuit comprises a crosspoint unit, and a multiple arbitration unit. The multiple arbitration unit comprises a request decoder, a prioritizer, a crosspoint select encoder and an acknowledge OR. The circuit operates such that if a source port is requesting a destination port that no other source port is requesting, then said requested destination port can be arbitrated simultaneously with requests by other source ports for other destination ports.

### BACKGROUND OF THE INVENTION

1. Field of the Invention

The present invention relates generally to an arbitration scheme for use in data interconnection and storage environments, and in particular, to an arbitration circuit that is adaptable for use as a switch core, especially in a fibre channel switch environment.

2. Description of Related Art

Mainframes, super computers, mass storage systems, workstations and very high resolution display subsystems are frequently connected together to facilitate file and print sharing. Common networks and channels used for these types of connections oftentimes introduce communications bottle necking, especially in cases where the data is in a large file format typical of graphically-based applications.

There are two basic types of data communications connections between processors, and between a processor and peripherals. A “channel” provides a direct or switched point-to-point connection between communicating devices. The channel's primary task is merely to transport data at the highest possible data rate with the least amount of delay. Channels typically perform simple error correction in hardware. A “network,” by contrast, is an aggregation of distributed nodes (e.g., workstations, mass storage units) with its own protocol that supports interaction among these nodes.

In most network applications, each node is tied into a switch or a “fabric” which may be a switch or collection of switches interconnected with each other. Once a node is connected into the fabric, it has access to all other nodes connected to the fabric.

One type of communications interconnect that has been developed is fibre channel.

The fibre channel protocol was developed and adopted as the American National Standard for Information Systems (ANSI). See Fibre Channel Physical and Signaling Interface, Revision 4.2, American National Standard for Information Systems (ANSI) (1993) for a detailed discussion of the fibre channel standard. Briefly, fibre channel is a switched protocol that allows concurrent communication among workstations, super computers and various peripherals. The total network bandwidth provided by fibre channel is on the order of a terabit per second. Fibre channel is capable of transmitting frames at rates exceeding 1 gigabit per second in both directions simultaneously. It is also able to transport commands and data according to existing protocols such as Internet protocol (IP), small computer system interface (SCSI), high performance parallel interface (HIPPI) and intelligent peripheral interface (IPI) over both optical fibre and copper cable. In addition to fibre channel, there are other protocols that include a crosspoint switch such as ethernet and asynchronous transfer mode (ATM) that are widely used in the industry for data communication.

System busses are generally used to provide communication between resources within a system such as processors, memories and input/output (“I/O”) devices. When a resource requires a connection to another resource, it must request access to the bus. An arbiter must decide if the resources can be connected via the bus based on the present state of the bus during the arbitration cycle. If the bus is not in use, the requesting resource is granted the bus. If the bus is busy, the arbiter monitors the state of the bus on subsequent arbitration cycles. If the bus quiesces or the arbiter determines that it is the requester's turn to take the bus, the arbiter will grant the bus to the requester.

Data communication hubs use a similar approach when attaching input ports to output ports. Each time an input port requires connection to an output port it requests a connection to that output port via a shared bus. The arbiter grants access to the bus based on a round robin priority scheme. While this approach to resource sharing works, it is not very efficient because only one connection through the switch can be active at any time. All resources must wait their turn to access another shared resource.

Data communication switches use a more efficient approach to sharing resources. They use crosspoint switches to connect input ports to output ports. Dedicated connections can exist between multiple input and output ports at the same time. The arbiter's task in this scenario is to make sure that the output port requested by an input port is not already connected to some other input port. If it is not, the connection is made. If it is, the requesting port waits for its turn to connect to that output. The distinct difference between a switch and a hub is that once the connection is made the arbiter can accept requests from other input ports for connection to other output ports without waiting for existing connections to terminate.

A deficiency in existing switches lies in the arbiter. When multiple input ports are requesting connections to multiple output ports, only one connection is arbitrated at a time. For example, port A requests a connection to port B and port C requests a connection to port D. Although these connections are mutually exclusive, they are not made at the same time. On one arbitration cycle, A connects to B and on the next arbitration cycle C connects to D. A novel way to alleviate this deficiency is to arbitrate for multiple destinations simultaneously.

Oftentimes in the context of a switch, particularly a fibre channel switch, connections and disconnections from various resources are competing for connection to various destination addresses through preassigned ports in the switch. As the port size of the switch increases, i.e., to levels up to 32 ports, or even 64 ports, the latency build up in the switch becomes exponentially increased with the level of data traffic therethrough. Thus, in larger switches, connect/disconnect performance can be hindered.

There exists a need in the art for development of a multiple arbitration scheme that would allow multiple sources and destination pairs to connect simultaneously, thereby reducing latency in the switch, and hence making connections and disconnections much faster and more reliable over time. Such a need is particularly prevalent in the case of fibre channel switches and associated Storage Area Networks (SANs).

### SUMMARY OF THE INVENTION

In accordance with these and other objects, there is provided a multiple arbitration circuit capable of simultaneously arbitrating multiple paths from n source ports to n destination ports at the same instance in time. Where n is between 1 and the maximum number of ports on a crosspoint switched bus.

The circuit comprises a crosspoint unit and a multiple arbitration unit. The multiple arbitration unit comprises a request decoder, a prioritizer, a crosspoint select encoder and an acknowledge OR. The circuit operates such that if a source port is requesting a destination port that no other source port is requesting, then that destination port can be arbitrated simultaneously with requests by other source ports for other destination ports.

In further accordance with the present invention, there are provided methods for moving data through a switch such as a director switch operating in a fibre channel director switch or storage area network, as well as methods for making and using such switches as well as methods for making and using arbitration circuits.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a block diagram representation of a multiple arbitration circuit according to one embodiment of the present invention.

FIG. 2 is a block diagram of a flow diagram of a multiple arbitration unit according to the present invention.

FIG. 3 is a circuit diagram of a prioritizer in greater detail according to one embodiment of the present invention.

FIG. 4 is a circuit diagram of an encoder according to one embodiment of the present invention.

FIG. 5 illustrates a destination selection data pathway in a multiple arbitration unit according to the present invention.

### DETAILED DESCRIPTION OF THE PREFERRED EMBODIMENT

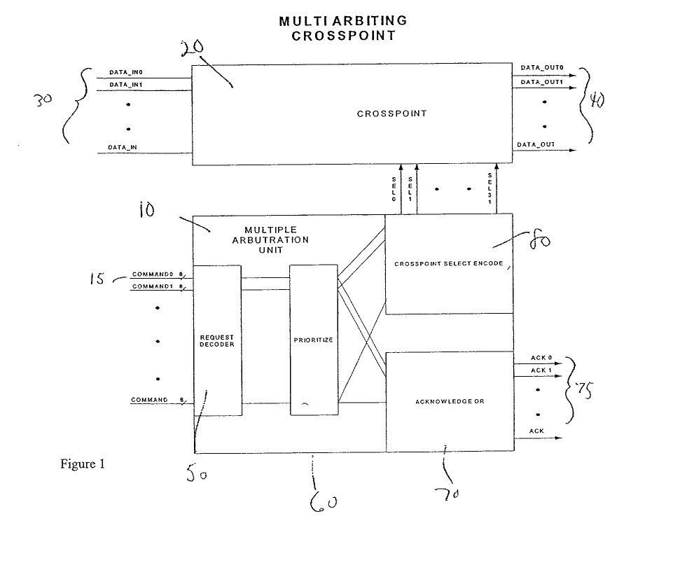

A multiple arbiting crosspoint switch according to one embodiment of the present invention, is shown in FIG. 1. The crosspoint switch of FIG. 1 has two major blocks, the multiple arbitration unit 10 and the data crosspoint switch 20. The crosspoint switch of FIG. 1 is typically capable of cross connecting multiple ports simultaneously. The multiple arbitration unit 10 decodes commands to make and break crosspoint connections. It also responds to flow control commands for starting and stopping arbitration. The data crosspoint switch 20 connects input ports 30 to output ports 40 (both of which can be six bits wide) under control of the multiple arbitration unit 10.

A multiple arbitration unit according to the present invention generally has the capability to simultaneously arbitrate multiple paths through a switch. If a source port is requesting a destination that no other source port is requesting, then that destination port can be arbited for at the same time other source ports are arbiting for other destination ports. In an “n” port switch, “n” ports can arbitrate for “n” separate destinations in a single arbitration cycle. In one embodiment a 32 port switch is employed, however, the instant circuit and method of arbitration could be applied to a switch of any size. Further, multiple arbitration is not limited to data-com switches. Multiple arbitration could be used in any bussed application such as CPU to Memory or CPU to I/O. For illustration purposes, a four port switch will be discussed.

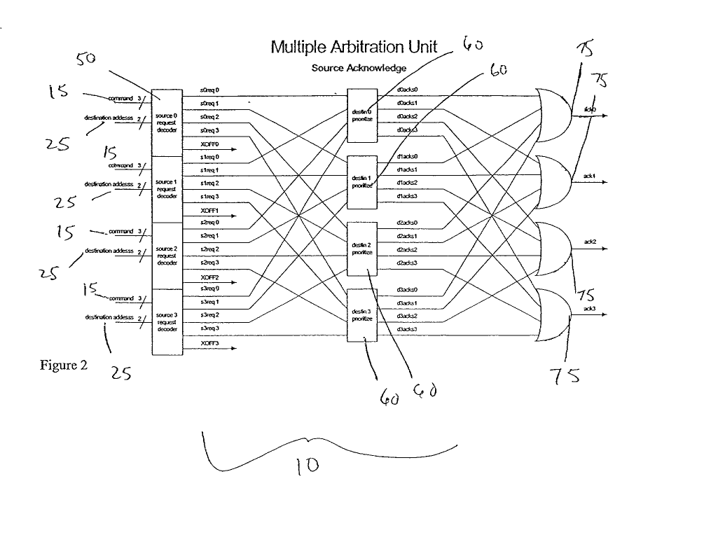

As shown, for example, in FIGS. 1 and 2, the multiple arbitration unit 10 of the present invention can have four sections, a Request Decoder 50, a Prioritizer 60, Acknowledge Or 70, and a Crosspoint Select Encoder 80. The Request Decoder (RD) 50 decodes a three-bit command 15 and a two-bit address 25 from the requester. Note that the bit command and address sizes can differ depending on the desired result and the number of ports being employed. There can be provided four commands recognized by the RD; connect, disconnect, XOFF, and XON.

If a connect command is detected, the two bit address 25 is decoded to its four bit values “sXreqY” where X is the source port making the request and Y is the destination being requested (See FIG. 2). The source port is implied by the circuit topology and not shown but understood by those of skill in the art.

If a disconnect command is detected, the two bit output is set to 0. XON and XOFF are used for flow control. When an XOFF command is detected, arbitration will be suspended for the destination port issuing the command until that same port issues an XON command. If a connection exists when the XOFF is issued, the current connection will be maintained until the disconnect command issues. Subsequent arbitration for new connections will then be suspended. To prevent stuck connections the ACKx signal 75 from the Acknowledge OR module 70 is monitored to determine if a connection exists. If the connection reaches a preset limit (or any other desired limit programmed or preselected depending on the circumstance) the four bit output will be set to zero and a new connect command must be detected to make a new connection.

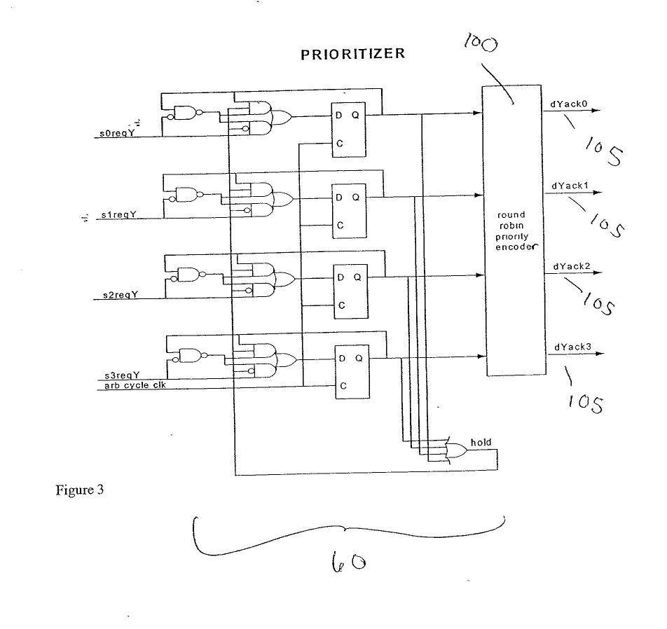

As shown in FIG. 3, the prioritizer gathers “like” requests from the request decoders and prioritizes them. There are preferably provided one prioritizer for each destination port. As illustrated herein, there would be 4 prioritizers, one for each destination port. For example, destination 1 prioritizer gathers requests from all decoders requesting access to destination 1. That is, the prioritizer looks at what destination each piece of data entering the switch is asking for, then determines which data should go first to each requested destination based on preprogrammed priority ranking. The requests can be prioritized, for example, using a round robin scheme 100. At reset, the priority is set to 0. If all 4 requests are then received in a single arbitration cycle, then request 3 would be acknowledged by asserting dYack3 105 (where Y is the destination and 3 is the source port being acknowledged) and holding it until it was removed by a disconnect command to the RD. A dYack2 to request 2 would be next, followed by a dYack1 to request 1, and finally a dYack0 to request 0.

The Prioritizer 60 samples the requests every arbitration cycle until one or more requests go active. The active requests, if more than 1, are then prioritized using any known method such as a round robin scheme 100. Subsequent requests are held off by the Hold signal until the current request is handled.

The Acknowledge Or (AO) 70 gathers all “like” acknowledges for the same source, and logically ORs them together. The acknowledge will remain active as long as a connection is valid. For a four port switch, there would be provided four Acknowledge Ors, one to acknowledge each input port.

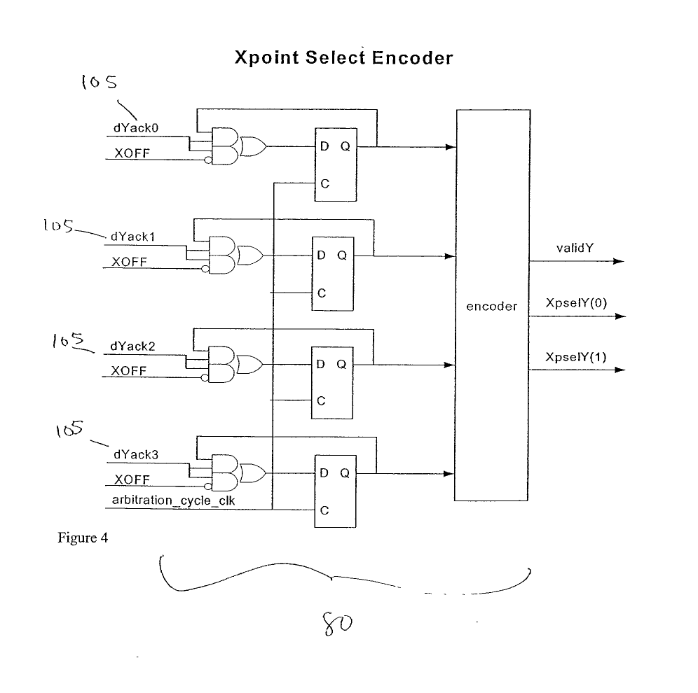

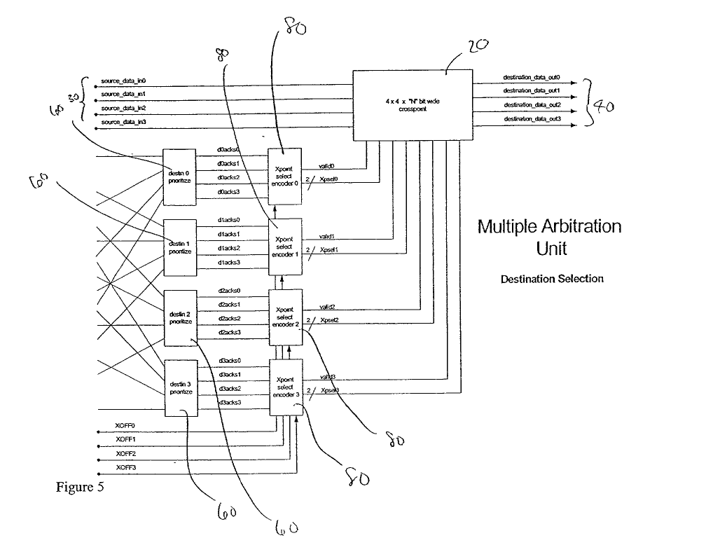

The Crosspoint Select Encoder (XSE) as shown for example, in FIG. 4, decodes the output of the destination prioritizer 60 and encodes the four-bit value into a two-bit crosspoint select value (Xpse1Y where Y is the crosspoint destination port) for the crosspoint. There would be four Crosspoint Select Encoders (XSE) for a four port switch as exemplified in FIG. 4. Note that the bit sizes and port characteristics are referred to herein as exemplary and other types of data sizes and characteristics could also be employed using a scheme and methodology of the present invention without undue experimentation. The XSE also outputs a valid bit when any of the four inputs are active. The XSE specifies the source that the destination will be connected to. For example, as shown in FIG. 5, if XSE1 had d0ack3 set on its input, then it would output a “11” on Xpse11 to the crosspoint source select for destination 1 causing source_data_in3 to be connected to destination_data_out1.

If an XOFF is received (high) from the RD, the XSE will continue to output any current Xpse1Y decode. When the current dYacksX is removed from the input, Xpse1Y and ValidY will be held low until XOFF goes low. When XOFF goes low, encoding can resume. This is best shown in FIG. 5.

The data crosspoint 20 is most preferably a non-blocking crosspoint. The data bus could be, for example, a serial or a parallel bus any number of bits wide. Note that a circuit of the present invention is adaptable, for example, in a fibre channel switch, ATM, or ethernet based protocols or any other similar or different architecture that employs an arbitrated crosspoint switch.

The entire circuit could be made up of several discrete devices, Programmable Logic Devices, Field Programmable Gate Arrays, or Mask Programmable Gate Arrays. Any one skilled in the art will realize that the implementation decision depends on how many paths are to be arbited for, how wide the data bus is, the speed of the data and the arbitration cycle time.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

As used herein and in the following claims, articles such as “the”, “a” and “an” can connote the singular or plural.

All documents referred to herein are specifically incorporated herein by reference in their entireties.

What is claimed is:

1. A multiple arbitration circuit capable of simultaneously arbitrating multiple paths from n source ports to n destination ports at the same instance in time.

2. The circuit according to claim 1 wherein n represents the maximum number of ports on said crosspoint switched bus.

3. The circuit according to claim 2 further comprising a multiple arbitration unit connected to the crosspoint switched bus.

4. The circuit according to claim 3 wherein said multiple arbitration unit includes a request decoder for decoding a requested destination port.

5. The circuit according to claim 3 wherein said multiple arbitration unit includes a prioritizer for determining a destination address for each piece of data entering the circuit and then prioritizing data for each requested destination based on preprogrammed priority ranking.

6. The circuit according to claim 5 wherein said multiple arbitration unit includes a crosspoint select encoder for decoding the output of the prioritizer and for encoding a crosspoint select value for said crosspoint switched bus.

7. The circuit according to claim 3 wherein said multiple arbitration unit includes an acknowledge OR for gathering acknowledges from said source ports and logically arranging said acknowledges based on predetermined characteristics.

8. A switch having n non-blocking paths, said switch comprising a circuit as claimed in claim 1.

9. A multiple arbitration circuit capable of simultaneously arbitrating multiple paths from at least one source port to at least one destination port through a switch comprising: a crosspoint switch and a multiple arbitration unit, said multiple arbitration unit comprising a request decoder, a prioritizer, a crosspoint select encoder and an acknowledge OR, wherein if a source port is requesting a destination port that no other source port is requesting, then said requested destination port can be arbitrated simultaneously with requests by source ports for other destination ports.

10. A circuit according to claim 9, wherein said switch is a 32 port switch, and 32 ports can arbitrate for 32 separate destinations in a single arbitration cycle of said circuit.

11. A storage area network comprising a director switch with a circuit as claimed in claim 9.

12. A method for making a director switch comprising the steps of obtaining a circuit as claimed in claim 1 and implementing said circuit in said director switch for the purpose of arbitrating datapaths therethrough.

13. A method for making a circuit usable in a switch having multiple source ports and multiple destination ports comprising the steps of: configuring a field programmable gate array such that when a source port is requesting a destination port that no other source port is requesting, then said destination port can be arbitrated simultaneously with requests by other source ports for other destination ports.

14. A method interconnecting processors and/or peripherals through a switch employing a multiple arbitration circuit having a crosspoint switched bus, said method comprising the steps of:
simultaneously arbitrating multiple paths from n source ports associated with said processors or said peripherals to n destination ports associated with said processors or peripherals at the same instance in time, wherein n represents the maximum number of ports on said crosspoint switched bus through said multiple arbitration circuit;
connecting at least one of said n destination ports to at least one of said n source ports.
